(19) United States
(12) Patent Application Publication
(10) Pub. No.: US 2003/0119941 A1
(43) Pub. Date: Jun. 26, 2003

(54) Ink for decoration of paper substrates for poster displays

(76) Inventors: Adam Joseph Howard Batting, Kent (GB); Paul James Chittenden, Kent (GB); Nigel Gould, Kent (GB)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/168,816

(22) PCT Filed: Dec. 19, 2000
(86) PCT No.: PCT/GB00/04832

(30) Foreign Application Priority Data
Dec. 23, 1999 (GB) 9930452.9

(51) Int. Cl. C03C 17/00; C09D 5/00

(52) U.S. Cl. 523/160; 523/161

(57) ABSTRACT

Inks are described for use in screen printing on paper or other substrates, especially for mounting as posters. The inks contain an oligomer or prepolymer, a water-soluble monomer, a photoinitiator and a pigment. The inks are preferably cured by ultra-violet irradiation. The cured print is well wetted by aqueous paste and does not curl away from a mounting surface.

The present invention concerns an ink that is suitable for decorating paper substrates. In particular, it concerns an ink curable by ultra-violet light that is suitable for printing black or coloured images on paper substrates for posters. This invention also concerns an ink for paper substrates which are mounted on surfaces using aqueous adhesive paste such as, for example, posters for exterior or interior display on bill-boards.

One method of producing mounted images is to first print a black or coloured image on to a paper substrate. The paper typically has a weight per unit area of between 100 and 150 grammes per square metre. The printed sheet is then soaked in water for a period of time such as, for example, between 1 hour and 7 days, usually between 1 day and 2 days. During this time the paper substrate absorbs water and swells. The soaked print is then mounted or applied to a flat surface which has been covered in an aqueous adhesive paste. The sheet may be alone or part of a multiple sheet set, and may be mounted next to or on top of other sheets or surfaces.

Inks for poster displays mounted with adhesive paste must possess many properties. They must, for example, be capable of being printed by an appropriate process such as, for example, screen process printing, flexographic printing or offset lithography. They must also show good wetting and adhesion on flexible sheet substrates such as, for example, paper. The ink should not “cockle” or distort the substrate on to which it is printed. Traditionally screen printing inks for this purpose were based on organic solvents, but increasingly solventless inks have been used (such as, for example, UV curable inks) which often contain water to reduce the cost and apply lower ink deposits when dried. During the printing process, a distortion of paper, known as “cockling”, can occur, which can be caused by water from the ink. This is usually seen when the level of water in the ink is above 20%. This is particularly problematic when printing multilayer images because any paper distortion adversely affects the final print quality. This is generally seen on lower weight papers such as, for example, 120 gsm, which are typically used in the production of posters.

After printing and drying on the substrate, the printed and dried ink layer must be elastic and flexible in order to undergo the processing of the print prior to mounting, and must continue to adhere well to the substrate when soaked in water. The substrate sheet bearing the printed and dried layer must not curl away from the mounting surface during and after mounting, and in practice the printed sheet, when soaked in the aqueous paste, should preferably exhibit curl towards the mounting surface, i.e. curl convexly with the printed ink layer outermost. The printed and dried layer on the sheet substrate, once mounted for display, should have external durability suitable for its purpose, and must be capable of being wetted smoothly by a later layer of aqueous adhesive paste without curling.

The nature of the ink plays an important part in determining the ease with which the mounted substrate can be produced and the performance of the finished article, in particular, to produce a durable image resistant to exposure. Inks based on volatile solvents are widely used, but they are less favoured because of the liberation of solvent vapour into the environment as the ink dries. Water-based inks do not produce hazardous vapour, but when printed on paper of the weights typically used, they can cause it to distort or cockle.

Non-aqueous photopolymerisable inks, that is to say, inks based on polymerisable materials which are cured or hardened by exposure to ultra-violet light, do not suffer from either of the drawbacks mentioned. They are also advantageous in that when they are used the final printed image is formed from a tough and resistant polymerised layer. Such inks are used for other types of printing such as, for example, offset printing of plastics substrates as described in WO 95 21422. Non-aqueous photopolymerizable compositions used as inks are however known to have certain limitations. Generally, a photopolymerisable ink shrinks on curing, i.e. the volume of the resulting hardened polymer is less than the volume of the unpolymerised liquid ink from which it is made. The cured layer also frequently lacks flexibility and elasticity.

When conventional ultra-violet cured inks are used to decorate paper substrate sheets for mounting using aqueous paste, the two factors (the shrinkage of the ink on curing and the swelling of the printed paper when soaked in water) combine to cause the soaked substrate to curl markedly away from the mounting surface. This causes difficulties in practice, particularly if several sheets are to be mounted side-by-side or one on top of another. Furthermore, the surface of the ink after it has been cured or hardened is also hydrophobic, making it more difficult to wet the surface of the print with an aqueous paste if another sheet is to be adhered.

A known type of photopolymerisable ink which also contains significant quantities of water shows much better wetting towards the paste compared to non-aqueous photopolymerisable inks, but also tends to cause the paper to cockle during the printing process, and can also change the density of colour by evaporation of the water during printing.

EP 317563 describes a process in which an ink, whether a conventional ultra-violet cured ink, a solvent-based ink or an aqueous ink containing less than 20% water, is used to print a first image on a paper sheet substrate. Such inks do not cause the paper to cockle, and are said to seal the surface in preparation for subsequent printings with an ultra-violet cured ink containing at least 40% water. This method is stated to reduce the curling of the printed sheet when it is immersed in water and pasted. However, it requires the use of two types of ink, namely: one type for the first sealing layer, and the second, aqueous, type for subsequent printing. In practice, it is also found that evaporation of water from the second type during printing can cause changes in the colour strength of the printed image. There is thus a requirement for an ultra-violet cured ink for poster printing which does not have these disadvantages.

The aim of the present invention is to provide an ink hardenable by ultra-violet irradiation for decoration of substrates such as paper.

A further aim of the present invention is to provide an ink for decorating substrates such as paper, which exhibits good wetting and adhesion to the substrate.

A further aim of the present invention is to provide an ink for decorating substrates such as paper, which is elastic and flexible so that it can withstand deformation of the substrate without cracking, flaking or loss of adhesion.

A further aim of the present invention is to provide an ink for decorating substrates such as 120 gsm poster paper, which, when soaked in water for 60 minutes, absorbs sufficient water compared to the substrate such that the ink film expands to an equal or greater extent than the substrate forming a flat or curled soaked print, where the print is outermost on the curled surface. This curled print with the printed side outermost is of benefit during the application of the poster by pasting to a mounting surface as it minimizes or negates the tendency of the edges of the print to curl away from the mounting surface and hence not adhere. This is due to the presence of hydrophilic groups in the cured polymer film that are incorporated by means of the water soluble monomers/oligomers in the formulation. The selection of the monomer/oligomer combinations should be such that there are sufficient hydrophilic groups in the resulting polymer after curing, to absorb sufficient water into the cured ink film to cause the substrate to remain flat or curl with the printed side outermost in the manner described above.

A further aim of the present invention is to provide an ink for decorating substrates such as paper, which does not exhibit unfavourable properties after soaking in water, such as, for example, poor adhesion or flexibility, or curling with the printed side innermost. When applied to the mounting surface by pasting, such a curled print will have a greater tendency to curl away from the mounting surface and is hence less desirable for purpose.

A further aim of the present invention is to provide an ink for decorating substrates such as paper, which, when mounted to a surface, exhibits good adhesion and low curl away from the mounting surface.

A further aim of the present invention is to provide inks for decorating substrates such as paper, which, once mounted, are able to accept the mounting of other printed materials over them.

A further aim of the present invention is to provide an ink that allows printing of single or multiple layers on to lightweight poster papers without an additional type of ink being required. EP 317 563 describes a process for producing posters which requires the use of such an additional type of ink.

In accordance with the present invention there is provided a radiation curable ink for multi-layer screen process printing of poster paper which is to be coated with an adhesive paste and mounted on to a billboard, the poster paper exhibiting reduced curl away from the billboard when the poster paper is mounted on to the billboard; the ink comprising:

(i) at least one photopolymerisable oligomer or prepolymer;

(ii) at least one ethylenically unsaturated, water-soluble monomer;

(iii) a photoinitiator or a mixture of photoinitiators;

(iv) a pigment or a mixture of pigments; and

(v) 0-20% by weight of water.

The photopolymerizable oligomer or prepolymer (i) is preferably a water-soluble or water-dispersible urethane resin, polyester resin or epoxy resin containing acrylate ester residues. More preferably, it is a water-soluble urethane acrylate resin. The photopolymerizable oligomer or prepolymer (i) is preferably present in the ink at a percentage by weight of between 5 and 50%, more preferably between 8 and 30%, most preferably between 10 and 20%.

The ethylenically unsaturated water-soluble monomer (ii) is preferably an ester of acrylic or methacrylic acid with polyethylene glycol or with a mono-, di-, tri- or tetra-hydric alcohol derived by ethoxylating with ethylene oxide a mono-, di-, tri- or tetra-hydric aliphatic alcohol of molecular weight less than 200. Examples of these are acrylate esters of polyethylene glycols made from a polyethylene glycol preferably having a molecular weight between 200 and 1500, more preferably between 400 and 1000, and most preferably between 600 and 800; and acrylate esters of ethoxylated trimethylolpropane preferably having between 9 and 30 ethoxylate residues, more preferably between 10 and 20 ethoxylate residues. Whilst the preferred monomer selection is a polyethyleneglycol type monomer, any monomer which can be solubilised in water by salt formation via the addition of acid or alkali or one that can fulfil the solubility criteria laid out in the examples section can be used. The ethylenically unsaturated water-soluble monomer (ii) is preferably present in an amount between 3 and 50%, more preferably between 8-30%, and most preferably between 10-20%.

The photoinitiator (iii) is preferably drawn from the types known as Norrish Types I and II, and is preferably capable of initiating the polymerization of the components (i) and (ii) when exposed to ultra-violet or visible light of wavelengths between 200 and 450 nanometres. It may be, for example, thioxanthone or a substituted thioxanthone such as, for example, isopropylthioxanthone, benzophenone or a substituted benzophenone, 1-hydroxycyclohexyl phenyl ketone, benzil dimethyl ketal, 2-benzyl-2-dimethylamino-(4-morpholinophenyl)butan-1-one, bis(2,6-dimethylbenzoyl)-2,4,4-trimethylpentylphosphine oxide. Mixtures of photoinitiators may preferably be used. The proportion by weight of photoinitiator is preferably between 0.5 and 10%, and more preferably 1-5%.

The pigment (iv) is selected to give the colour desired in the ink, for example, Pigment Black 7, Pigment Blue 15:3, Pigment Red 170 or Red 184, Pigment Yellow 83 or Yellow 151, Pigment Violet 19, Pigment Orange 34 or Orange 43, or Pigment Green 7. Especially preferred are black and the colours required for 4 colour process printing. Blends of pigments may preferably be used. The pigment may be incorporated in the composition as a powder, but it is preferred to use pigments pre-dispersed in a liquid medium. Such dispersions are known commercially under various tradenames such as, for example, “Aquarine” from Tennant Textile Colours, “Flexonyl” from Clariant and “Unisperse” from Ciba Speciality Chemicals. In these dispersions the liquid medium may be water, a mixture of water and a water-soluble solvent, a plasticizer, an oligomer or monomer of the types described as components (i) and (ii) above, or a mixture of these components. The proportion by weight of the pigment is between 0.5 and 40%, preferably 1.5 to 10%, most preferably 2.5 to 6%.

Optionally included is an ethylenically unsaturated monomer that is insoluble in water, which is preferably an acrylate or methacrylate ester of a mono-, di-, tri-, tetra-, penta- or hexa-hydric alcohol, preferably having a molecular weight less than 300. Preferred examples are tripropyleneglycol diacrylate, tris(hydroxymethyl)propane triacrylate, pentaerythritol tetra-acrylate. The proportion by weight of this monomer is preferably between 0 and 50%, more preferably between 10 and 45%, and most preferably between 30 and 40%.

Other ingredients of types known in the art are optionally present such as, for example, surfactants, defoamers, flow aids, stabilisers, plasticizers, reodorants, extenders, gellants, matting agents, identifying tracers for security purposes, and synergists for the photoinitiators.

The ink preferably includes less than 15% of water, more preferably less than 10% water, more preferably less than 7% of water, more preferably less than 5% water, even more preferably less than 3% water and most preferably less than 1% water.

The ingredients are mixed to give the final ink by standard methods such as, for example, stirring on a low- or high-speed stirrer, or milling on a triple-roll mill, a sand-mill or a bead-mill.

The inks may be used on many substrates, but the preferred substrate is paper, preferably having a weight per unit area of between 100 and 150 grammes per square metre. The inks may be applied by various means such as, for example, screen process printing, offset lithography, flexography, or pad printing. They are preferably applied to the substrate by screen process printing such as, for example, through a metal or polyester mesh preferably having between 120 and 180 threads per centimetre.

After application to the substrate, the ink is preferably cured or hardened by exposure to ultra-violet light, preferably having a wavelength between 200 and 420 nanometres. The source of this may be, for example, a medium pressure mercury lamp of power preferably between 80 and 150 Watts per centimetre, or a flash-curing xenon lamp, for example, emitting light energy at 13.66 Joules per centimetre for 0.1 second.

The ink may be used for billboard poster printing in which the poster is mounted using an adhesive paste, and also for other types of large format poster printing.

By way of example only, the invention will now be described with reference to the following examples, in which all parts are by weight.

### EXAMPLES

Twelve formulations were prepared using the following procedure, in which X and Y are components specified in the formulations section following the preparation method.

Preparation Method

The following components were mixed on a Greaves stirrer to give a homogeneous liquid:

| | | |
|---|---|---|
| Actilane SP061 | 16.42 | parts |
| (water-soluble urethane acrylate from Ackros) | | |
| Benzophenone | 1.79 | parts |
| Byk 035 (defoamer from BYK Chemie) | 0.94 | parts |
| Cab-O-Sil M5 (silica from Cabot GmbH) | 1.50 | parts |
| Darocure 1173 (photoinitiator from CIBA) | 1.42 | parts |
| Genorad 16 (stabiliser from Rahn AG) | 0.56 | parts |
| Igepal CO-897 | 2.91 | parts |
| (surfactant from Caldic UK Ltd) | | |
| Irgacure 369 (photoinitiator from CIBA) | 0.56 | parts |
| Talc | 24.25 | parts |
| Tripropyleneglycol diacrylate | 31.68 | parts |
| Component X | 14.47 | parts |
| Component Y | 3.50 | parts |

Stirring was continued until no nibs were visible on a Hegman gauge.

### Example Formulations

| | Component X | Component Y |
|---|---|---|
| Example 1a | Ebecryl 11 (water-soluble | Unisperse Blue GPI |
| | acrylate from UCB) | (dispersion of |
| | | Pigment Blue |
| | | 15:3 from Ciba) |
| Example 1b | Ebecryl 11 (water-soluble | Flexonyl Rubine F6-B |
| | acrylate from UCB) | (pigment dispersion |
| | | from Clariant) |
| Example 1c | Ebecryl 11 (water-soluble | Aquarine Yellow 3G |
| | acrylate from UCB) | (pigment dispersion |
| | | from Tennants) |
| Example 1d | Ebecryl 11 (water-soluble | Aquadisperse Black CB- |
| | acrylate from UCB) | EP (pigment dispersion |
| | | from Tennants) |
| Example 2a | Craynor 435 (water-compatible | Unisperse Blue GPI |
| | Monomer from Cray Valley | (dispersion of Pigment |
| | Products) | Blue 15:3 from Ciba) |
| Example 2b | Craynor 435 (water-compatible | Flexonyl Rubine F6-B |
| | Monomer from Cray Valley | (pigment dispersion from |
| | Products) | Clariant) |
| Example 2c | Craynor 435 (water-compatible | Aquarine Yellow 3G |
| | Monomer from Cray Valley | (pigment dispersion |
| | Products) | from Tennants) |
| Example 2d | Craynor 435 (water-compatible | Aquadisperse Black CB- |
| | Monomer from Cray Valley | EP (pigment dispersion |
| | Products) | from Tennants) |
| Example 3a | Tripropyleneglycol diacrylate | Unisperse Blue GPI |
| | | (dispersion of Pigment |
| | | Blue 15:3 from Ciba) |
| Example 3b | Tripropyleneglycol diacrylate | Flexonyl Rubine F6-B |
| | | (pigment dispersion from |
| | | Clariant) |
| Example 3c | Tripropyleneglycol diacrylate | Aquarine Yellow 3G |
| | | (pigment dispersion from |
| | | Tennants) |
| Example 3d | Tripropyleneglycol diacrylate | Aquadisperse Black CB- |
| | | EP (pigment dispersion |
| | | from Tennants) |

Examples 1a, 2a and 3a were cyan inks; examples 1b, 2b and 3b were magenta inks; examples 1c, 2c and 3c were yellow inks and examples 1 d, 2d and 3d were black inks.

It should be noted that component X in examples 1a-1d is Ebecryl 11 which is described as water-soluble. Examples 2a-2d component X is Craynor 435 which is described as water-compatible rather than water-soluble and examples in 3a-3d component X is tripropyleneglycol diacrylate which can be described as non-water-soluble.

Results

The twelve examples prepared above were split into three sets, namely examples 1a-1d were grouped together, 2a-2d were grouped together and 3a-3d were grouped together. In these groupings the examples form sets of inks suitable for use in 4 colour screen process printing.

An A5 block area image was printed using each of examples 1a, 2a and 3a through a 150.34UOPW mesh on to 120 gsm blue-backed poster paper, such as that supplied by Moulin Vieux or Lenzing. Each print was cured using two medium pressure 80W/cm mercury arc lamps with a belt speed of 30m/min. This process was repeated, directly overprinting these prints with examples 1b, 2b and 3b respectively, and continued such that examples 1c, 2c and 3c and finally examples 1d, 2d and 3d were overlaid. This produced prints with four cured overprinted layers, the layers being in the order of cyan, magenta, yellow and black, one print for each set of examples 1a-1d, 2a-2d and 3a-3d (hereafter refered to as prints 1, 2 and 3). These prints were then soaked for 1 hour in water. The prints were observed during the soaking period; all the prints showed initial curl with the printed side innermost. After approximately two minutes print 1 had reversed its curl such that the desired curl with the printed side outermost was given. Print 2 uncurled a little but did not reverse its curl. Print 3 did not show this reverse curl and instead continued to curl with the printed side innermost. After the 1 hour soaking period had elapsed, print 1 was curled with the print side outermost and prints 2 and 3 were curled with the print side innermost; print 3 had curled more than print 2. Print 1 showed good adhesion and flexibility before, during and after the water soak.

The wet, curled prints were then removed from the water and left to dry on a flat, horizontal surface. After 24 hours all three prints appeared to be dry. Print 1 still showed some curl with the print side outermost; prints 2 and 3 were still curled with the print side innermost.

This experiment was repeated up to the soaking stage. After soaking for 1 hour all three prints were removed from the water and immediately applied to a vertical mounting surface with a water-based adhesive paste. Print 1 did not show curl away from the surface. Print 2 showed some curl away from the mounting surface and print 3 showed a large amount of curl away from the mounting surface.

Solubility of Monomers in Water

To test the solubility of monomers in water the following test was employed:

A sample containing 5 g of the monomer under test and 100 mls of water was mechanically shaken vigourously for 10 mins. The sample was then allowed to rest for 24 hours. Any sign of separation into two distinct layers was recorded. If separation was observed then this indicated the monomer has a solubility less than 50 g/litre. If no layers were observed the test was repeated with an extra 5 g of monomer. The test was repeated until separation was observed or the quantity of monomer reached 100 g.

The amount of monomer which can added into the water without separation is a good measure of the monomer's ability in a cured ink to give reduced or no curl away from the vertical mounting surface when affixed with a waterbased paste.

In order to achieve this improved performance the monomer should have a solubility in water of at least 50 g/litre or preferably 200 g/litre or more preferably 400 g/litre.

The solubility in water, as determined by the above method, of the monomers tripropyleneglycol diacrylate, Craynor 435 from Cray Valley Products and Ebecryl 11 from UCB is recorded below.

| | Tripropyleneglycol | | |
|---|---|---|---|
| Monomer | diacrylate | Craynor 435 | Ebecryl 11 |
| Solubility in | <50 g/litre | 200 g/litre | 1000 g/litre |
| Water | | | |

1. A radiation curable ink for multi-layer screen process printing of poster paper which is to be coated with an adhesive paste and mounted on to a billboard, the poster paper exhibiting reduced curl away from the billboard when the poster paper is mounted on to the billboard; the ink comprising:
(i) at least one photopolymerisable oligomer or prepolymer;
(ii) at least one ethylenically unsaturated, water-soluble monomer;
(iii) a photoinitiator or a mixture of photoinitiators;
(iv) a pigment or a mixture of pigments; and
(v) 0-20% by weight of water.

2. The ink as claimed in claim 1, wherein the photopolymerizable oligomer or prepolymer (i) is water-soluble or water-dispersible.

3. The ink as claimed in claims 1 and 2, wherein the photopolymerizable oligomer or prepolymer (i) is a water-soluble urethane acrylate resin.

4. The ink as claimed in any one of the preceding claims, wherein the photopolymerizable oligomer or prepolymer (i) is present in the ink at a percentage by weight of between 5 and 50%, preferably between 8 and 30%, and more preferably between 10 and 20%.

5. The ink as claimed in any one of the preceding claims, wherein the ethylenically unsaturated water-soluble monomer (ii) has a solubility in water between 50 g/litre and complete miscibility, preferably between 200 g/litre and complete miscibility and more preferably between 400 g/litre and complete miscibility.

6. The ink as claimed in any one of the preceding claims, wherein the ethylenically unsaturated water-soluble monomer (ii) is an ester of acrylic or methacrylic acid with polyethylene glycol or with a mono-, di-, tri- or tetra-hydric alcohol derived by ethoxylating with ethylene oxide a mono-, di-, tri- or tetra-hydric aliphatic alcohol of molecular weight less than 200.

7. The ink as claimed in claims 5 or 6, wherein the ethylenically unsaturated water-soluble monomer (ii) is an acrylate ester of a polyethylene glycol, preferably a polyethylene glycol having a molecular weight between 200 and 1500, more preferably between 400 and 1000, and most preferably between 600 and 800; or an acrylate ester of ethoxylated trimethylolpropane, preferably having between 9 and 30 ethoxylate residues, more preferably between 10 and 20 ethoxylate residues.

8. The ink as claimed in any one of the preceding claims, wherein the ethylenically unsaturated water-soluble monomer (ii) is present in an amount between 3 and 40%, preferably between 8-30%, and more preferably between 10-20%.

9. The ink as claimed in any one of the preceding claims, further including an ethylenically unsaturated monomer that is insoluble in water.

10. The ink as claimed in claim 9, wherein the ethylenically unsaturated monomer that is insoluble in water is an acrylate or methacrylate ester of a mono-, di-, tri-, tetra-, penta- or hexa-hydric alcohol, preferably having a molecular weight less than 300.

11. The ink as claimed in claims 9 or 10, wherein the ethylenically unsaturated monomer that is insoluble in water is tripropyleneglycol diacrylate, tris (hydroxymethyl)propane triacrylate or pentaerythritol tetra-acrylate.

12. The ink as claimed in claims 9, 10 or 11, wherein the ethylenically unsaturated monomer that is insoluble in water is present in an amount between 0 and 50%, preferably between 10 and 45%, and more preferably between 30 and 40%.

13. The ink as claimed in any one of the preceding claims, wherein the photoinitiator (iii) is a type known as Norrish Type I and II, and is preferably capable of initiating the polymerization of the components (i) and (ii) when exposed to ultra-violet or visible light of wavelengths between 200 and 420 nanometres.

14. The ink as claimed in claim 13, wherein the photoinitiator (iii) is a thioxanthone or a substituted thioxanthone, preferably selected from: isopropylthioxanthone, benzophenone or a substituted benzophenone, 1-hydroxycyclohexyl phenyl ketone, benzil dimethyl ketal, 2-benzyl-2-dimethylamino-(4-morpholinophenyl)butan-1-one, bis(2,6-dimethylbenzoyl)-2,4,4-trimethylpentylphosphine oxide, or mixtures thereof.

15. The ink as claimed in any one of the preceding claims, wherein the proportion by weight of photoinitiator is between 0.5 and 10%, preferably 1-5%.

16. The ink as claimed in any one of the preceding claims, wherein the pigment is pre-dispersed in a liquid medium.

17. The ink as claimed in claim 16, wherein the liquid medium is water, a mixture of water and a water-soluble solvent, a plasticizer, an oligomer or monomer of the types described as components (i) and (ii) above, or a mixture of these components.

18. The ink as claimed in any one of the preceding claims, wherein the proportion by weight of the pigment is between 0.5 and 40%, preferably 1.5-10%, more preferably 2.5-6%.

19. The ink as claimed in any one of the preceding claims, further including an inorganic filler, preferably selected from: china clay, talc or calcium carbonate.

20. The ink as claimed in any one of the preceeding claims, wherein the ink includes less than 15% of water, preferably less than 10% water, more preferably less than 7% of water, more preferably less than 5% water, even more preferably less than 3% water and most preferably less than 1% water.

21. A method of multi-layer printing on to a substrate, the method including the step of using the ink claimed in any one of claims 1-20 for the multi-layer printing, the method not requiring the use of a base coat on the substrate before the multi-layer printing in order to reduce cockling or distortion of the substrate.

22. The method claimed in claim 21, wherein the multiple layers used in the multi-layer printing are at least two different colours.

23. The method claimed in claims 21 or 22, wherein the substrate is paper having a weight per unit area of between 100 and 150 grammes per square metre.

24. The method claimed in claims 21, 22 or 23, wherein the substrate is a billboard poster or other type of large format poster.

25. The method claimed in claims any one of claims 21 to 24, wherein the ink is applied to the substrate by screen process printing, preferably through a metal or polyester mesh, which preferably has between 120 and 180 threads per centimetre.
